(19) United States
(12) Patent Application Publication
(10) Pub. No.: US 2015/0133596 A1
(43) Pub. Date: May 14, 2015

(54) USE OF LITHIUM POLYACRYLATE AS A DISPERSANT

(71) Applicant: BK GIULINI GMBH, Ludwigshafen (DE)

(72) Inventors: Thomas Staffel, Grunstadt (DE); Siegbert Weber, Ladenburg (DE); Marina Fleischhauer, Langenbrucken (DE)

(73) Assignee: BK GIULINI GMBH, Ludwigshafen (DE)

(21) Appl. No.: 14/398,258

(22) PCT Filed: Apr. 26, 2013
(86) PCT No.: PCT/EP2013/001268

§ 371 Date: Oct. 31, 2014

(30) Foreign Application Priority Data
May 5, 2012 (DE) 10 2012 009 320.9

(51) Int. Cl. C09D 133/08; C08K 3/34; C08K 3/26; C09D 133/02; C08K 3/22

(52) U.S. Cl. CPC C09D 133/08; C09D 133/02; C08K 3/22; C08K 3/26; C08K 3/34; C08K 2003/2241
USPC 524/522

(57) ABSTRACT

The invention relates to the use of fully-neutralised lithium polyacrylate as a dispersant in painting agents, which contain a binding agent system based on silicate particles having an average particle size of under 100 nm and which are chemically cross-linked with a polymeric binding agent, as well as painting agents, in particular emulsion paints, containing colourants and a binding agent system based on silicate particles that are chemically cross-linked with a polymeric binding agent, having an average particle size of under 100 nm in an aqueous dispersion or emulsion, and with lithium polyacrylate as the dispersant.

The present invention relates to paints that contain nanoparticles as components

Painting agents, also known as painting materials, consist of materials or mixtures ranging from liquid form to paste form, which, when applied to surfaces, produce a physically or chemically drying coating. According to DIN 55945, a painting material is a “liquid to paste-like coating material that is primarily applied by spreading or rolling.”

A painting material is fundamentally composed of: binding agents, colourants, solvents and, for the most part, fillers, as well as potential additives such as thickening agents, dispersants and preservatives. Painting agents are subdivided according to their film-forming binding agents, which are in turn divided into organic and inorganic binding agents, and which produce the product classes:
varnishes
emulsion paints
liquid plaster.

Examples of organic binding agents are the oils from oil paints, acrylic resins or epoxy resins, which typically produce varnishes or lacquers. Further organic binding agents are, above all, acrylate polymers or vinyl acetate copolymers, which are components of commercially available emulsion paints. For natural paints, natural binding agents such as casein are also used. Examples of inorganic binding agents are quicklime, cement, anhydrite, ettringite and potassium water glass, which are used in the building industry and wall painting. Water glass serves as a binding agent in silicate paints.

High-viscosity painting agents, which consist of a chemical dispersion (in most cases an emulsion) made from binding agents and solvents, colourants (in most cases pigments) and additives, are known as emulsion paints. In this general sense, the plurality of liquid painting agents (varnishes, paints) are dispersions.

Nowadays, numerous requirements are posed for painting agents. A particular problem with façade paints consists in that many indentations and scratches are present on the mostly rough surface of the façade, in which pollutants and microorganisms may settle. In addition, there are very severe fluctuations in temperature, since façades are becoming more and more insulated and the surface of the façade thus no longer has any thermal contact with the wall. Thus, the surface cools down significantly during the night, water condenses and the problem of dirtying, particularly by microbial processes, intensifies.

In order to prevent an attack on the painted surface by microorganisms such as algae or fungi, film preservation typically takes place, i.e. a biocidal equipping of the coating, which is effective in the hardened and dried state. The active agents such as fungicides, algaecides and bactericides only have a limited level of water solubility, in order that they are not washed off by weathering. They still often lose their effect after a few years. In the case of discolouration of the surface by microbial attack, which then occurs, the paint must typically be renewed.

Besides the classic, organically bonded emulsion paints, silicon resin paints, in which organic polymers serve as binding agents and in which silicate particles are additionally contained, are also included as emulsion paints. Similarly to the inorganically bonded silicate paints, silicon resin paints are highly permeable for water vapour, combined with the advantages of the organically bonded emulsion paints.

With a newer development, an attempt is made to protect the surface of paints from microorganisms by incorporating nano-particles. Nano-particles are understood to be solid particles having a particle size of under 1 μm, often around 100 nm and below. With so-called nanohybrid technology, polymer-silicate binding agents are used for façade paints, which contain chemically cross-linked nano-particles, e.g. silica sol particles, in a polymeric binding agent, e.g. in an acrylate binding agent. The nano-particles are finely distributed in the polymer matrix and thus form a reinforcement of this matrix in the form of a network. The consequence is a sealing of the surface against pollution and ingress of water. Nanohybrid binding agents are commercially available, for example under the name Mowilith Nano by Celanese and SilaClean by Carparol; see, for example, “technikforum”, January 2007 edition by Caparol Farben Lacke Bautenschutz GmbH, p 7-9. The façade paints having these binding agents have a nano-structured surface and display good durability, resistance to weathering and vapour permeability, as well as a reduced tendency for contamination.

However, it became apparent in practice that the colour films of the paints based on nanohybrid binding agents have a stronger tendency towards formation of cracks when ageing, compared to those from paints having conventional acrylate binding agent systems. The formation of cracks is noticeable by the fact that so-called nibs are formed on the surface, similar to running droplets; FIG. 2 shows such a crack formation.

There is therefore a need for further improvement.

Surprisingly, it has now been found that lithium polyacrylate as a dispersant can clearly reduce the formation of cracks in painting materials with nanohybrid binding agent systems.

The above object is therefore solved by the use of fully-neutralised lithium polyacrylate as a dispersant for painting agents containing silicate particles having an average particle size of under 100 nm and which are chemically cross-linked with a polymeric binding agent, and by painting agents, in particular emulsion paints, containing silicate particles that are chemically cross-linked with a polymeric binding agent, said particles having an average particle size of under 100 nm, and lithium polyacrylate.

A further advantage of the dispersant used according to the invention and the painting agent according to the invention is an improved rheological stability of the dispersions compared to those with typically used dispersants such as polyphosphates and polyacrylates or other polymers in the form of painting agents stabilised by sodium, potassium or ammonium salt. Painting agents according to the invention therefore also have improved shelf life.

The applied dispersion films also display improved wall adhesion.

The invention has proved to be particularly expedient for all painting agents formulated with a nanohybrid binding agent system, but in particular for emulsion paints and most preferably for façade paints.

The painting agents according to the invention contain, in an aqueous dispersion/emulsion, at least the silicate particles that are cross-linked with the polymeric binding agent, colourants, mainly pigments but also dyes, as well as the dispersant. Moreover, fillers and additives such as thickeners, as well as preservatives, are typically contained. With respect to colourants, fillers and additives, substances that are known as such are suitable in their typical quantities.

The silicate that is chemically cross-linked with polymeric binding agent is in itself known. The polymer is typically an acrylate, for example a homo or copolymer or acrylic acid and/or methacrylic acid and/or esters thereof, as well as potentially, in the case of copolymers, further olefinically unsaturated monomers such as vinyl acetate. Acrylic acid homo polymers are currently preferred. The silicate particles are typically silica sol particles. The average particle size is below 100 nm, typically 80 nm, in particular in the range of from 10 to 50 nm, preferably from 20 to 30 nm. In commercial binding agent dispersions, the solids content is mostly from 30 to 50% by weight, of which e.g. approximately 40% by weight are silicate particles. In the formulation of the painting agents, 20 to 40% by weight, in particular 25 to 30% by weight of binding agent dispersions are typically used.

The lithium polyacrylates used according to the invention as dispersants are also known in themselves: see, for example, WO 2010/070407, WO 2009/124871 and U.S. Pat. No. 5,424,259. They are typically provided as aqueous solutions. The solids content is typically from 20 to 60% by weight, preferably 30 to 45% by weight. According to the invention, acrylic acid homopolymers that are completely neutralised with lithium are used. Quantities of 0.1 to 5% by weight, preferably 0.2 to 1% by weight of lithium polyacrylate, have proved particularly expedient.

Conventional siliceous and carbonatic fillers are suitable as fillers. At least one, often several, filler(s) is/are typically contained.

Moreover, typical colourants are contained in the painting agents according to the invention. These are mostly pigments and, depending on the paint, are also combinations of pigments. Titanium dioxide is particularly widespread as a colourant, since virtually all painting agents are manufactured with white as their base colour. If other colour tones are desired, further pigments and/or colourants are mixed in. Titanium dioxide also ensures, as well as the white colour, opacity, potentially in combination with the filler(s). The colourant is mostly contained in quantities ranging from 10 to 20% by weight.

Preservatives are normally also contained in the painting agents according to the invention. On the one hand, they ensure a preservation of the painting agent up to its use. In this respect it is required that the painting agent can be stored for a longer period of time up to its use, as well as in the opened containers. The conventional preservatives are suitable for this container preservation in the quantities that are known per se.

Moreover, thickeners, emulsifiers, pH regulators, defoamers, complexing agents and other typical additives are contained individually or as a mixture in the quantities that are known per se.

A standard façade paint formulation according to the invention consists, for example, of the following components: 100 to 120 parts water, 250 to 300 parts nanodispersion, e.g. based on copolymers of acrylic acid and methacrylic acid, 0.1 to 10 parts fully-neutralised lithium polyacrylate, 100 to 150 parts titanium dioxide/white pigment, 250 to 400 parts siliceous and carbonatic fillers, 1 to 5 parts thickener, 2 to 4 parts defoamer, 3 to 5 parts non-ionogenic dispersant, 10 to 15 parts water-repellent material and 10 to 15 parts film-forming agent. Furthermore, preservatives and biocidally-active agents can also be present.

The production and finishing of the painting agents take place in a known manner and do not need to be illustrated in any greater detail here. The painting agents are obtained by mixing the solid and liquid components in suitable mixing devices. Painting agents according to the invention can be applied by brushing or rolling, spraying etc., and to that end are adapted in terms of their consistency, as is usual.

The invention is to be illustrated with the aid of the following examples, without, however, being limited to the specifically described embodiments. Insofar as nothing else is specified or occurs in a necessarily different manner depending on context, percentage values relate to the weight, and, in case of doubt, the total weight of the mixture.

The invention also relates to all combinations of preferred embodiments, insofar as these are not mutually exclusive. The specifications “about” or “approx.” in connection with a numerical figure mean that values that are higher or lower by at least 10%, values that are higher or lower by 5% and at least values that are higher or lower by 1% are included.

### EXAMPLE 1

The effect of the dispersion according to the invention was compared to those of typical dispersants. To that end, the following standard façade paint formulation was used: 110.5 parts water, 1.5 parts thickener, 2.0 parts defoamer, 3.0 parts non-ionogenic dispersant, 120 parts titanium dioxide, 460 parts mixture of siliceous and carbonatic fillers, 275 parts silica sol chemically cross-linked with copolymers of acrylic acid and methacrylic acid, 15 parts water-repellent material and 13 parts film-forming agent.

In this standard formulation, the quantities of non-ionogenic polymer or fully-neutralised lithium polyacrylate specified in Table 1 were used as dispersants instead of a corresponding quantity of water, and the viscosity was determined after 1 week and 4 weeks of storage at 50° C. The viscosities are also specified in Table 1.

TABLE 1

| | Quantity (parts) | | | | | |
|---|---|---|---|---|---|---|
| Dispersant | | | | | | |
| non-ionogenic | 4.0 | | | | | |
| polymer | | | | | | |
| Li-Polyacrylate | | 5.0 | 4.0 | 3.0 | 2.0 | 1.0 |
| Viscosity | | | | | | |
| after 1 week | | | | | | |
| at 0.1 s⁻¹ | 1000 | 260 | 221 | 240 | 253 | 348 |
| at 0.251 s⁻¹ | 527 | 150 | 129 | 139 | 145 | 194 |
| at 1 s⁻¹ | 192 | 61.8 | 54 | 57.1 | 59.1 | 74.8 |
| at 10 s⁻¹ | 34.6 | 14.3 | 12.6 | 13.1 | 13.2 | 15.4 |
| at 100 s⁻¹ | 6.72 | 3.42 | 3.11 | 3.13 | 3.13 | 3.39 |
| Viscosity | | | | | | |
| after 4 weeks | | | | | | |
| at 0.1 s⁻¹ | 1220 | 382 | 280 | 286 | 306 | 372 |
| at 0.251 s⁻¹ | 632 | 216 | 161 | 164 | 173 | 206 |
| at 1 s⁻¹ | 214 | 85.3 | 65.4 | 65.8 | 69.5 | 79.7 |
| at 10 s⁻¹ | 35.5 | 18 | 14.8 | 14.5 | 15.2 | 16.3 |
| at 100 s⁻¹ | 6.49 | 4.18 | 3.61 | 3.49 | 3.59 | 3.7 |

It can clearly be seen that the paints according to the invention, even with low quantities of dispersant, have better storage stability; the viscosity did not increase as significantly.

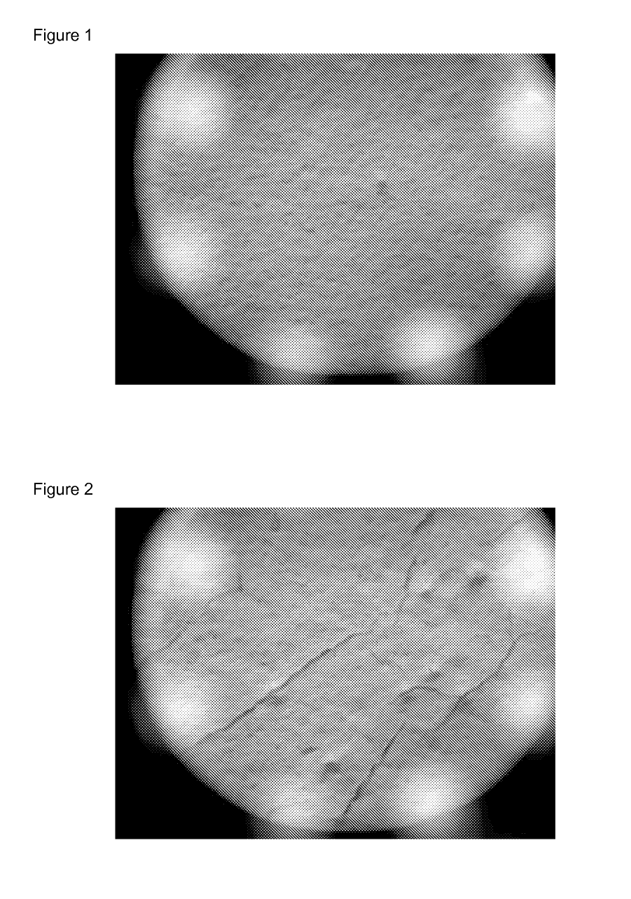

To investigate the crack-resistance, test walls consisting of fibre cement panels were coated with the emulsion paints produced according to the above formulation and subjected to a weathering test. The paints were applied with the scraper with a layer thickness of 400 μm. The paints contained 1 part fully-neutralised lithium polyacrylate or 4 parts non-ionogenic dispersant. FIG. 1 (invention, with 1 part lithium polyacrylate) and 2 (prior art, with 4 parts non-ionogenic dispersant) show the photographs of the walls with the colour films after 4 weeks' storage with enlargement by a factor of 30. The formation of cracks can clearly be seen for the dispersant according to the prior art, which does not occur with the lithium polyacrylate used according to the invention.

1. Use of fully-neutralised lithium polyacrylate as a dispersant in painting agents, which contain a binding agent system based on silicate particles that are chemically cross-linked with a polymeric binding agent, having an average particle size of under 100 nm.

2. Use according to claim 1, wherein the average particle size of the silicate particles is ≦80 nm, preferably ranging from 10 to 50 nm, particularly preferably ranging from 20 to 30 nm.

3. Use according to claim 1, wherein the polymeric binding agent is an acrylate binding agent, preferably an acrylic acid homopolymer or a copolymer of acrylic acid and/or methacrylic acid and/or esters thereof.

4. Use according to claim 1, wherein the painting agent is an emulsion paint, preferably a façade paint.

5. Use according to claim 1, wherein 0.1 to 5% by weight, preferably 0.2 to 1% by weight of lithium polyacrylate is used.

6. Painting agent containing colourants and a binding agent system based on silicate particles that are chemically cross-linked with a polymeric binding agent, having an average particle size of under 100 nm in an aqueous dispersion or emulsion, wherein fully-neutralised lithium polyacrylate is contained as the dispersant.

7. Painting agent according to claim 6, wherein the polymeric binding agent is an acrylate binding agent, preferably a homopolymer of acrylic acid or methacrylic acid or a copolymer of acrylic acid and/or methacrylic acid and/or esters thereof

8. Painting agent according to claim 6, wherein the average particle size of the silicate particles is ≦80 nm, preferably ranging from 10 to 50 nm, particularly preferably ranging from 20 to 30 nm.

9. Painting agent according to claim 6, wherein it contains fillers, preferably selected from siliceous and carbonatic fillers.

10. Painting agent according to claim 6, wherein it contains one or more additives.

11. Painting agent according to claim 6, wherein it is an emulsion paint, preferably a façade paint.

12. Method for the dispersion of painting agents that contain a binding agent system based on silicate particles that are chemically cross-linked with a polymeric binding agent, having an average particle size of under 100 nm, characterised in that fully-neutralised lithium polyacrylate is used as the dispersant.

13. Method according to claim 12, wherein average particle size of the silicate particles is ≦80 nm, preferably ranging from 10 to 50 nm, particularly preferably ranging from 20 to 30 nm.

14. Method according to claim 12, wherein an acrylate binding agent, preferably an acrylic acid homopolymer or a copolymer of acrylic acid and/or methacrylic acid and/or esters thereof, is used as the polymerous binding agent.

15. Method according to claim 12, wherein the painting agent is an emulsion paint, preferably a façade paint.

16. Method according to claim 12, wherein 0.1 to 5% by weight, preferably 0.2 to 1% by weight of lithium polyacrylate is used.
